(19) United States
(12) Patent Application Publication
(10) Pub. No.: US 2005/0060240 A1
(43) Pub. Date: Mar. 17, 2005

(54) Method and system for space-shifting music files

(76) Inventor: Garry Popofsky, Scaredale, NY (US)

Correspondence Address: Philip Braginsky;Seully, Scott, Murphy & Presser, 400 Garden City Plaza, Garden City, NY, 11530, US

(21) Appl. No.: 10/943,187

(22) Filed: Sep. 16, 2004

Related U.S. Application Data
(60) Provisional application No. 60/504,842, filed on Sep. 17, 2003.

(51) Int. Cl. G06F 17/60

(52) U.S. Cl. 705/26

(57) ABSTRACT

A method of providing music data in a compressed digital format, such as MP3, MP3PRO, or WAV, in which a music recording incorporated on one of an analog and a digital recording medium is sent, such as via courier or mail, or otherwise provided by a user to a collection center, the received music recording is converted to data of the compressed digital format and provided, for example over a network, including via wireless connection, to the user, and user music preference information is tracked for future sale or targeted promotions. Also, the data may be provided when demanded by the user for playback, including via streaming. Further, the compressed digital format data may be provided to the user by storing the compressed digital format data on a playback medium provided for user use. The recording medium may be purchased from the user and sold on a secondary market.

### RELATED APPLICATION

This Application is based on provisional patent Application No. 60/504,842, filed on Sep. 17, 2003.

### FIELD OF THE INVENTION

The invention generally relates to converting file formats and transmitting converted files to a user. Specifically, the invention space-shifts licensed music files to an encoded compressed format and transmits those files to the licensed user.

### BACKGROUND OF THE INVENTION

Compressed digital music files including, but not limited to, MP3, WAV, and MP3PRO, are gaining acceptance as viable alternatives to compact disks, magnetic tapes and vinyl records. These coding schemes result in the compression of original sound data from a compact disk or other digital or analog format without sacrificing sound quality. The compressed digital files are easier to use, transport and store compared with other formats.

The ease of manipulation, transport and storage has contributed to the proliferation of file-sharing, file-swapping and unauthorized use of recorded music in digital format. The music industry has devised several responses to eliminate unauthorized usage. None of these responses have been overly successful, so the industry is still formulating strategies to prevent the unauthorized proliferation of digital music files.

With MP3 and other compression techniques available, many people now desire to recreate their old collection in these new formats. To collect digitally stored music one may illegally download music from websites such as the now defunct Napster. These unauthorized files can be stored on a hard drive, portable listening device such as an iPod, or transferred to a compact disk. Many consumers shy away from illegal downloads because they are intimidated by the process, the process is illegal, and the music quality is inconsistent and unreliable. A second option is to legally download music from various digital music providers such as Apple's iTunes Music Store. This cost is roughly the same as purchasing a compact disk but there are limitations on the breadth of offerings and use. Legal downloads still require a consumer to repurchase a license to music files that they might already own. A third option is to convert previously purchased music (i.e. vinyl records and compact disks) to digital format on a personal computer. This cost is largely one of time, opportunity and frustration in addition to some allocated cost of the computer and software.

Music consumers face the additional confusion of having music in several formats without an easy way of making them uniform. For example, one may have recordings in vinyl, magnetic tape, compact disks and MP3 files on a digital storage medium. There exists no easy way to integrate, store, and access this collection using convenient playback devices.

By space-shifting data files, transforming the data files to different file extensions or formats, lawful users may use their data in different places and on different devices. Making copies of music files to render them portable is attractive to legal owners of music files in non-portable formats such as vinyl. This population is large and generally reluctant to pay for a new license to copyrighted music for which they already own a license.

The lack of an easy to use, cost-effective method for purchasing new digital music and managing previously owned music in digital format has slowed consumer acceptance of digital music.

### SUMMARY OF THE INVENTION

The invention is directed to a system and method for providing recorded audio programming in a digital form of a consumer's choice. The system comprises a computer server capable of copying, storing and transferring audio programming in a time-compressed, encoded format through various means. The system comprises means for converting or space-shifting recordings on different media, including but not limited to, vinyl records, magnetic tapes, and compact disks, to a compressed digital format. Along with the associated electronics and processors, the converting means comprises a reading or playback device such as a compact disk player or record turntable, an analog to digital converter, a memory, and conversion means usually implemented by software. The conversion means converts or space-shifts a file from one format to a compressed digital format, e.g. .WAV to .MP3. The consumer may pay a fee associated with the conversion of files.

In one aspect of the invention a consumer physically provides a collection of legally licensed music in analog form to a drop-off center where the original files are converted to digitally encoded music files and transmitted back to the consumer. In another aspect of the invention, the consumer provides digital music on compact disks to be converted. In a further aspect, the consumer electronically provides the music collection to be encoded via the Internet or other network. The drop-off center can be an automated kiosk or a manned center.

In one aspect of the present invention, the encoded music is delivered back to the consumer on storage media capable of being read by a personal computer, a portable listening device, a home audio system and/or a car audio system. In another aspect of the invention, the encoded music may be returned to the consumer by streaming to an appropriate receiving and playback device.

### BRIEF DESCRIPTION OF THE DRAWINGS

FIG. 1 is a diagram of a system according to an embodiment of the invention.

FIGS. 2-5 are diagrams of methods of the invention, according to embodiments of the invention.

### DETAILED DESCRIPTION OF THE INVENTION

In accordance with the present invention, the server can be of known devices such as an audio/video server, FTP server, network file server, or a web server that serves content to a Web browser by loading a file from a disk and serving it across the network to a user's Web browser using HTTP. A proxy server can be used between the client and the external server to filter requests, improve performance, and share connections.

The system can store the space-shifted files for a time determined by the consumer or some other time interval. The system also provides a remotely accessible, secure, computer server on-line for storage of the space-shifted music files. The consumer may pay a fee for the storage of the files.

Additionally, a secure wired or wireless transmission system may be used to transfer on demand, the files from the server to an audio receiver/player. The transmission system can be cellular, satellite, radio frequency, IEEE 802.1 1 compatible, Internet, a computer network or other known transmission system. The receiver may comprise a mobile or fixed cellular, satellite, or radio receiver, a memory and a playback system capable of playing the music files in “real-time” or to a data storage device. Transmission may also be via a modem using a conventional voice/data 2-way communications gateway or broadband connection such as cable or an optical pathway and the receiver a known terminal or device for such transmissions.

The transmission system would automatically, or upon a request, transmit the compressed audio files to the consumer's receiver or storage device. The consumer can choose which files are to be transmitted or transmit all files at once. Consequently, the invention includes software and methods for administering the server that manages the variables relevant to a mobile device/server environment. Fleet management on the server for administering information in this network includes, but is not limited to, user data, user groups, group channels, channel data, personal channels, commercial channels, user accounts, personal information management, device configuration, device databases, device contents, and device parameters.

Additionally, the invention contemplates a consumer having a digital audio player or an auxiliary hard drive, loaded with the consumer's music. These players have become well known and widespread since their size and weight are compact and they produce high quality audio output. Digital audio players typically include a digital signal processor, a memory, a power supply and a headphone. Examples of such a digital audio player are the Apple iPod.

The invention also comprises means for tracking and analyzing consumer usage. These means includes software that collects and monitors data on a particular consumer, e.g. what genre of music they purchase and collect, time of day preferences, purchasing history. This data can be sold or used to target market consumers.

The method of the present invention comprises space-shifting a consumers existing collection of music to a compressed digital format. This can be accomplished by a drop-off service in selected locations such as, but not limited to, shopping mall kiosks, drop sites at music retailers, sites at computer hardware retailers, and a mail-in service directly to a conversion center. The conversion center houses the system capable of converting, storing and transmitting the compressed files. Once converted, the compressed audio file(s) can be e-mailed to the consumer, delivered to the consumer on a portable listening device or auxiliary hard drive or transmitted to the customer. Additionally, the compressed audio file(s) can be transmitted to separate storage facility.

The consumer may be offered the opportunity to purchase a portable listening device or auxiliary hard drives to receive transmitted files and these devices can be delivered in their blank state or pre-loaded with the compressed files and additionally with newly purchased music. The invention also offers consumers the opportunity to store their music in an on-line storage locker that is remotely accessible and secure.

Further, conversion can involve the consumer's sale of the original music format. The method may also comprise the sale of the original music files to the secondary market.

The method also comprises targeted sales to consumers including, but not limited to, additional music, soundtracks, concert tickets, t-shirts and memorabilia. The invention also supplies multiple industries with information gathered from the consumer's usage of the invention that will further drive the sale of music and other products.

The method provides for conversion of existing music collections to digital format, the sale of music collection data, on-line storage of converted music and new music purchases, sale of hardware devices used to play digital music, and sale of original pre-recorded music (non-digital) to a secondary market.

### DETAILED DESCRIPTION OF THE DRAWINGS

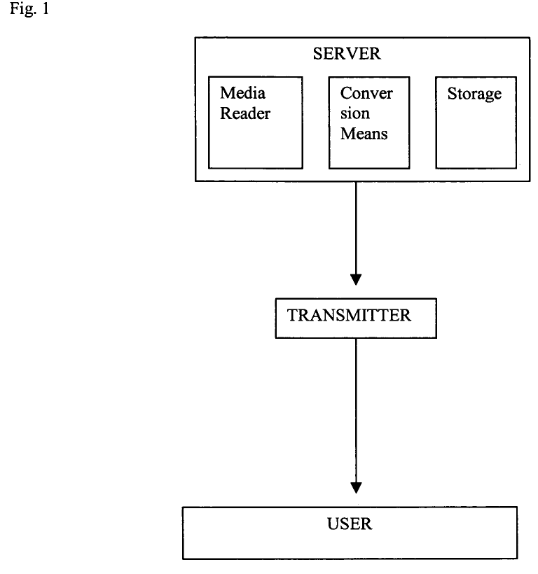

FIG. 1 depicts the system of the invention. The server comprises a media reader. The media reader can be a compact disk reader, vinyl record player, magnetic tape deck or other known device. The server can also be electronically and/or digitally in communication with the server from a remote location. The remote location can be of any distance.

The server also comprises conversion means that is typically implemented via software. There are many known software tools that provide conversion of a music file from one format to another (“space-shifting”). The formats include but are not limited to, analog, .WAV, .MP3, and other known formats. The system is not dependent on specific file formats and is capable of converting any known format to another. What is preferred is that all the music files be encoded into a compressed digital format that substantially maintains the fidelity of the original format.

Additionally, the server comprises storage capabilities. The storage can be implemented as non-volatile or volatile memory. In the volatile embodiment, the server either transmits the encoded files to the user or transmits the files to some other non-volatile memory device for later transmission.

The system further comprises a means for transmission. The transmission means can be of any known type but is preferably a web server that provides access to a user through a web browser. Another preferred transmission is by storing the encoded music files on a non-volatile memory capable of being read by a portable listening device. This memory is then delivered to the user via postal mail or in-person. Other means include, RF, IEEE 802.11, cellular, satellite or wired transmission. Any known method capable of transmitting encoded music files to a user is adequate for the invention, and the invention is not dependent on any one method.

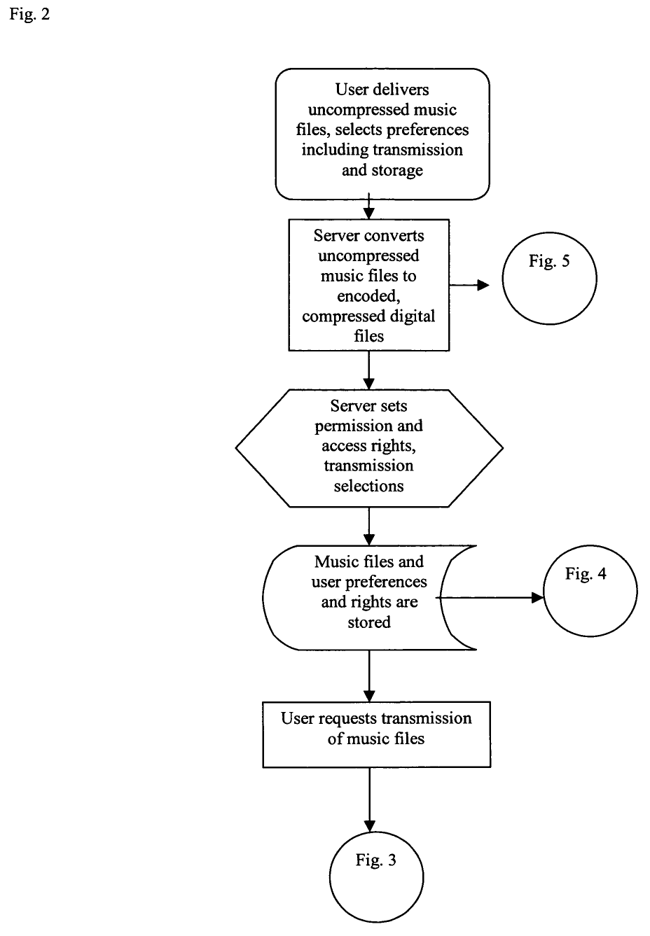

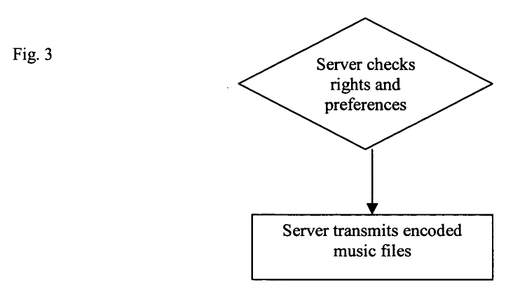

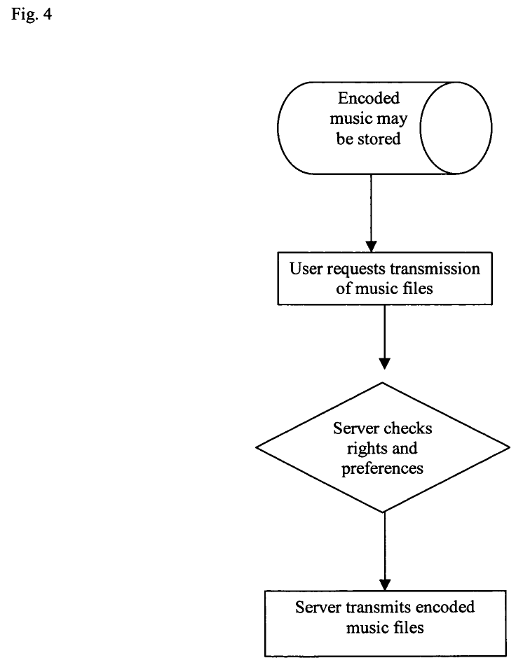

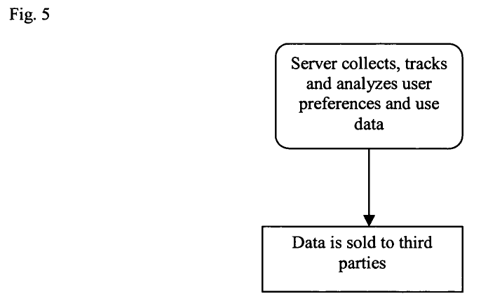

FIG. 2 depicts the method of the present invention. The first step of the present method requires a user to deliver music files to the system of the present invention. This is preferably accomplished by a remote, centrally located center. The drop-off center may be in a shopping mall or other convenient location. The drop-off center may be manned or automated as a kiosk. The method provides for charging retail outlets or other locations a fee to house the drop-off centers. The invention also provides for the user to electronically “drop-off” the music files via a network connection such as the Internet. Preferably, the user goes to a drop-off center at a mall and leaves presently owned compact disks at the drop-off center. This step may be associated with charging a fee to the user.

The method further provides for the user's files to be space-shifted to another format. This typically involves transferring the compact disks to an .MP3 format, though any formats are applicable. At this stage the user's music preferences and licenses may be recorded and stored. The user can specify preferences such as files formats, type of transmission, addresses, and other information. The user can also customize a locker for storage and remote and/or on-demand access of the encoded music files. A fee can be associated with obtaining a locker.

On demand or at some other specified time, the encoded files are transmitted to the users specified location or address. Alternatively, the files can be stored on a portable memory within a portable listening device or capable of being played by a listening device. Alternatively, the files can be streamed from the server by known technology upon demand of the user.

The invention is not limited to any file formats. Fees may be associated with any defined step of the method. Accordingly, it should be readily appreciated that the system and method of the present invention has many practical applications. Additionally, although the preferred embodiments have been illustrated and described, it will be obvious to those skilled in the art that various modifications can be made without departing from the spirit and scope of this invention.

1. A method of providing music data in a compressed digital format, comprising:
sending by a user a music recording incorporated on one of an analog and a digital recording medium to a collection center;
converting the received music recording to data of the compressed digital format;
providing compressed digital format data to the user; and
tracking user music preference information.

2. The method of claim 1, wherein the compressed digital format is one of an MP3 format, an MP3PRO format, and a WAV format.

3. The method of claim 1, wherein the compressed digital format data is uploaded to a server before said providing of the compressed digital format data.

4. The method of claim 1, wherein said providing of the compressed digital format data is via a network.

5. The method of claim 4, wherein the compressed digital format data is provided to the user via a wireless connection.

6. The method of claim 4, wherein the compressed digital format data is provided when demanded by the user for playback.

7. The method of claim 1, wherein the compressed digital format data is provided to the user for playback via streaming the data.

8. The method of claim 1, wherein the compressed digital format data is provided to the user by storing the compressed digital format data on a playback medium provided for user use.

9. The method of claim 1, wherein the playback medium is a portable playback device.

10. The method of claim 1, wherein after said converting, the recording medium is sold on a secondary market.

11. The method of claim 1, wherein the user sends the recording medium via one of a courier and mail.

12. The method of claim 1, further comprising at least one of targeting the user for a music purchase offer based on the information and selling the music preference information.

13. A method of providing music data in a compressed digital format, comprising:
delivering by a user a music recording incorporated on one of an analog and a digital recording medium to a collection center;
converting the received music recording to data of the compressed digital format;
providing the compressed digital format data for the user; and
tracking user music preference information.

14. The method of claim 13, wherein the compressed digital format is one of an MP3 format, an MP3PRO format, and a WAV format.

15. The method of claim 13, wherein the providing of the data for the user is performed by first uploading the compressed digital format data to a server.

16. The method of claim 13, wherein the compressed digital format data is provided to the user via a network.

17. The method of claim 13, wherein the compressed digital format data is provided to the user via a wireless connection.

18. The method of claim 13, wherein the compressed digital format data is provided when demanded by the user for playback.

19. The method of claim 13, wherein the compressed digital format data is provided to the user for playback via streaming the data.

20. The method of claim 13, wherein the compressed digital format data is provided to the user by storing the compressed digital format data on a playback medium provided for user use.

21. The method of claim 18, wherein the playback medium is provided on a portable playback device.

22. The method of claim 13, wherein after said converting, the recording medium is sold on a secondary market.

23. The method of claim 13, further comprising at least one of selling the user music preference information and targeting the user for a music purchase offer based on the music preference information.
